(19) United States
(12) Patent Application Publication
(10) Pub. No.: US 2025/0278853 A1
(43) Pub. Date: Sep. 4, 2025

(54) METHOD OF TRAINING A NEURAL NETWORK FOR POSE DETECTION

(71) Applicant: Honda Motor Co., Ltd., Tokyo (JP)

(72) Inventors: Zhihao Zhao, Sunnyvale, CA (US); Reza Ghoddoosian, San Jose, CA (US); Isht Dwivedi, Mountain View, CA (US); Nakul Agarwal, San Francisco, CA (US); Behzad Dariush, San Ramon, CA (US)

(21) Appl. No.: 18/639,873

(22) Filed: Apr. 18, 2024

Related U.S. Application Data
(60) Provisional application No. 63/561,204, filed on Mar. 4, 2024.

(51) Int. Cl. G06T 7/73; G06V 10/44; G06V 20/40; G06V 40/20

(52) U.S. Cl. CPC G06T 7/73; G06V 10/44; G06V 20/49; G06V 40/20; G06T 2207/20081; G06T 2207/20084; G06T 2207/30201

(57) ABSTRACT

A computer-implemented method of training a neural network for pose detection. The method includes obtaining a test video with a plurality of actions, inputting RGB features from the test video to a video encoder, and applying the video encoder to the RGB features from the test video to output RGB feature embeddings. The method further includes inputting pose features from the test video to a pose encoder, applying the pose encoder to the pose features from the test video to output pose feature embeddings, and mapping the RGB feature embeddings and the pose feature embeddings to a shared representation space. The method further includes utilizing a contrastive loss to train the video encoder and identifying one or more action segments in the test video using the trained video encoder.

### CROSS REFERENCE TO RELATED APPLICATION

This application claims the benefit of U.S. Provisional Patent Application Ser. No. 63/561,204 filed on Mar. 4, 2024 and titled “Leveraging External Pose Knowledge for Weakly-Supervised Human Action Segmentation in Long Instructional Videos”, the disclosure of which is incorporated by reference in its entirety.

### BACKGROUND

This disclosure relates generally to neural networks, and in particular to a method of training a neural network for pose detection to recognize action segmentation in instructional videos.

Recognizing human action in a long instructional video holds significance owing to its role in facilitating comprehension and learning for intelligent systems. By accurately identifying and understanding human actions depicted in instructional videos, the intelligent systems may grasp the sequential steps involved in performing complex tasks. This comprehension aids in skill acquisition, as the intelligent systems may observe and emulate the demonstrated actions, supporting the automation of performance analysis and monitoring in industrial applications.

One big challenge with recognizing human action lies in the fact that precisely labeling each frame of these videos demands intensive human labor to annotate the starting and ending times of action segments, rendering the process cumbersome and time consuming. Consequently, the goal for the intelligent systems is to understand human actions in long video with minimal human-crafted supervision.

There is a need in the art for a method of training a neural network for improved pose detection to recognize human action segmentation in instructional videos.

### SUMMARY

In one aspect, a computer-implemented method of training a neural network for pose detection is provided. The method includes obtaining a test video with a plurality of actions, inputting RGB features from the test video to a video encoder, and applying the video encoder to the RGB features from the test video to output RGB feature embeddings. The method further includes inputting pose features from the test video to a pose encoder, applying the pose encoder to the pose features from the test video to output pose feature embeddings, and mapping the RGB feature embeddings and the pose feature embeddings to a shared representation space. The method further includes utilizing a contrastive loss to train the video encoder and identifying one or more action segments in the test video using the trained video encoder.

In another aspect, a computer-implemented method of using a trained neural network to perform action segmentation of a subject video is provided. The method includes training a neural network embodied in a video encoder with a test video to infuse pose knowledge into the trained neural network. The method also includes providing a subject video to the trained neural network and segmenting the subject video into one or more actions with associated labels and durations utilizing the trained neural network.

Other systems, methods, features and advantages of the disclosure will be, or will become, apparent to one of ordinary skill in the art upon examination of the following figures and detailed description. It is intended that all such additional systems, methods, features and advantages be included within this description and this summary, be within the scope of the disclosure, and be protected by the following claims.

### BRIEF DESCRIPTION OF THE DRAWINGS

The disclosure may be better understood with reference to the following drawings and description. The components in the figures are not necessarily to scale, emphasis instead being placed upon illustrating the principles of the disclosure. Moreover, in the figures, like reference numerals designate corresponding parts throughout the different views.

FIG. 1 is a flowchart of an exemplary method of training a neural network for pose detection in accordance with aspects of the present disclosure;

FIG. 2 is a schematic view of an example embodiment of a process of training a neural network for pose detection using a test video in accordance with aspects of the present disclosure;

FIG. 3 is a representative view of an example embodiment of mapping pose features in frames of a test video in a shared representation space in accordance with aspects of the present disclosure;

FIG. 4 is a flowchart of an exemplary process of pose encoding for training a neural network for pose detection in accordance with aspects of the present disclosure;

FIG. 5 is a flowchart of an exemplary process of contrastive learning for training a neural network for pose detection in accordance with aspects of the present disclosure;

FIG. 6A is a formula for determining an RGB to pose contrastive loss (Equation 4);

FIG. 6B is a formula for determining a pose to RGB contrastive loss (Equation 5);

FIG. 7A is a representative view of an example embodiment of a first type of contrastive learning in accordance with aspects of the present disclosure;

FIG. 7B is a representative view of an example embodiment of a second type of contrastive learning in accordance with aspects of the present disclosure;

FIG. 7C is a representative view of an example embodiment of a third type of contrastive learning in accordance with aspects of the present disclosure;

FIG. 8 is a flowchart of an exemplary method of using a trained neural network to identify action segmentation in instructional videos in accordance with aspects of the present disclosure;

FIG. 9 is a representative view of an example embodiment of using a trained neural network to identify action segmentation in instructional videos in accordance with aspects of the present disclosure;

FIG. 10 is a table (Table 1) showing results of online segmentation in accordance with aspects of the present disclosure;

FIG. 11 is a table (Table 2) showing results of offline segmentation in accordance with aspects of the present disclosure;

FIG. 12 is a table (Table 3) showing a comparison of different contrastive learning processes in accordance with aspects of the present disclosure;

FIG. 13 is a table (Table 4) showing results of a trained neural network for pose detection in accordance with aspects of the present disclosure; and

FIG. 14 is a table (Table 5) showing a comparison of methods of online segmentation in accordance with aspects of the present disclosure.

### DETAILED DESCRIPTION

A method of training a neural network for pose detection to recognize action segmentation in instructional videos is described herein. The example embodiments provide weakly-supervised learning methods for recognizing human actions in long instructional videos with minimal human supervision. Specifically, a neural network is provided that incorporates external pose knowledge during training but abstains from using it during testing, thus distilling important pose knowledge regarding each action element. Noticeably, the neural network does not require pose information during the inference time while achieving better performance than proposed baseline methods. The trained neural network is validated through extensive experiments on representative datasets and outperforms previous state-of-the-art methods in segmenting long instructional videos under both online and offline settings. Additionally, the neural network's adaptability is provided to various segmentation backbones, pose extractors, and contrastive learning methods for knowledge distillation.

The example embodiments are described herein with reference to a weakly supervised neural network where specific start and end times for each action in a video are not known. The techniques of the present embodiments incorporate pose information into a weakly supervised neural network, emphasizing its crucial role in recognizing human actions. Pose information is informative due to its ability to encode rich information about body movements, gestures, and interactions, which are essential for a nuanced understanding of human actions. Specifically, pose information enables the decomposition of each action into a series of more granular representations, leading to more discriminative features within the same action segment and aiding in the identification of similarities across different actions. For example, in an assembly task, the action “fasten screw” can be broken down into reaching for the screw and rotating the screw, each characterized by unique poses despite sharing the same action label. Moreover, pose information is particularly discriminative during action transitions, making it a powerful feature to supervise learning and estimate the start and end times of actions in videos with weak labels, where detailed frame-level annotations are absent.

The method of the present embodiments leverages both appearance and gesture cues by combining RGB and pose modalities. While extracting pose information is beneficial in some instances, it also introduces significant computational costs that may hamper real-time performance in interactive applications. To address this issue, the present embodiments utilize a neural network that infuses pose information from a standard pose estimator into the video encoder during training. During testing, however, the disclosed neural network relies exclusively on the RGB modality. In particular, the techniques described herein utilize a contrastive learning process to enable the neural network to differentiate between corresponding and non-corresponding RGB and pose features. By establishing a frame-level correspondence between RGB and pose features to create a positive pair, and by using different contrastive learning techniques to identify negative pairs, the method of the present embodiments facilitates the learning of features within a combined pose-RGB representation space.

As used herein and in the claims, “online” refers to causal inference in streaming videos for interactive applications, whereas “offline” refers to post-analysis of pre-recorded videos.

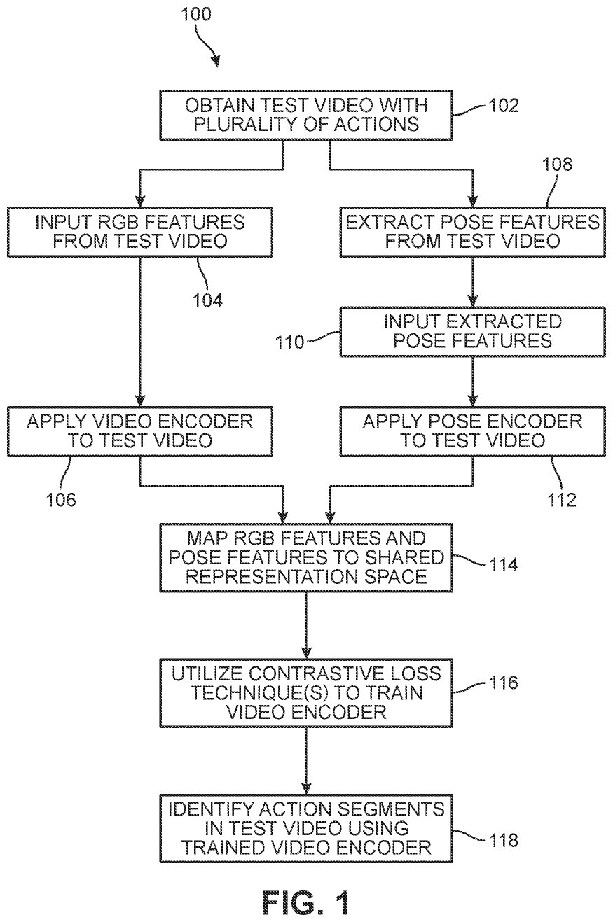

Referring now to FIG. 1, a flowchart of an exemplary method 100 of training a neural network for pose detection is shown. In an example embodiment, method 100 may begin with an operation 102 where a test video including a plurality of actions is obtained. For example, operation 102 may utilize an instructional video featuring a human subject performing a sequence of actions that are associated with a specific task as a test video. This test video may include a transcript of the actions performed by the human subject but does not include any start or stop times associated with the actions themselves (i.e., weakly supervised).

Next, method 100 may proceed to an operation 104. At operation 104, the test video including a plurality of RGB features are provided as an input. These RGB features represent the pixels of the video frames of the test video. Method 100 then proceeds to an operation 106 where a video encoder utilizing an untrained neural network is applied to the test video to extract the RGB features from the test video and associate the video frames of the test video with the extracted RGB features (e.g., embedding) to provide an output in the form of RGB feature embeddings. Method 100 also includes an operation 108 where pose features from the same test video are extracted. These pose features represent the coordinates of various keypoints of the human subject (e.g., reference points associated with the face, hands, and/or body) from the video frames of the test video. For example, at operation 108 a pre-trained pose extractor or other off-the-shelf estimator may be used to extract the pose features from the test video.

At an operation 110, the extracted pose features are provided as an input to a pose encoder. Next, method 100 includes an operation 112 where the pose encoder is utilized to associate the video frames of the test video with the extracted pose features (e.g., embedding) provided as an input from operation 110 to provide an output in the form of pose features embeddings. Once the RGB features have been extracted and embedded by the video encoder at operation 106 and the pose features have been associated with the video frames (e.g., embedded) at operation 112, method 100 may proceed to an operation 114. At operation 114, the RGB feature embeddings (e.g., output from operation 106) and the pose feature embeddings (e.g., output from operation 112) are mapped to a shared representation space. That is, at operation 114, both the embedded RGB features and the pose features from the test video are transformed into a joint RGB-pose space (i.e., the shared representation space) with consistent feature dimensions. With this arrangement, RGB features and pose features contained in each frame of the test video (e.g., embedded) may be represented using a common coordinate system.

Next, method 100 proceeds to an operation 116. At operation 116, one or more contrastive loss techniques are utilized to train the video encoder. For example, as will be described in more detail below, the contrastive loss techniques utilized at operation 116 may include one or more types of contrastive learning processes that contrast samples against each other to learn features that are common and features that are different between action labels. This contrastive learning process allows the video encoder to learn semantically rich visual representations that are enriched by pose data during training.

Method 100 next proceeds to an operation 118. At operation 118, the RGB features from the test video (e.g., from operation 104) are then input into the trained video encoder using a chosen weakly-supervised segmentation baseline to decode the final output into one or more identified action segments within the test video.

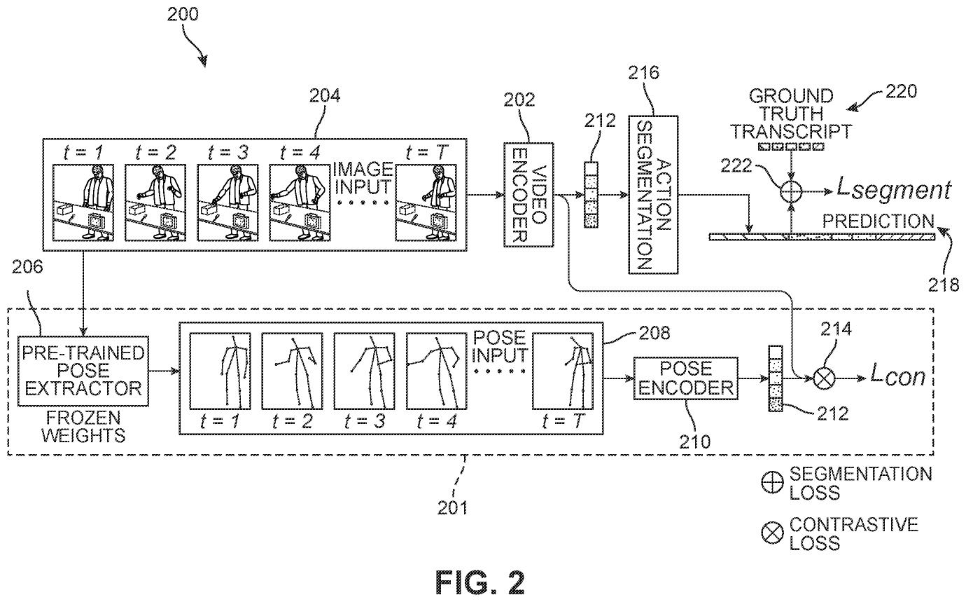

Referring now to FIG. 2, a schematic view of an example embodiment of a process 200 of training a neural network for pose detection using a test video is shown. In this embodiment, the neural network is embodied in a video encoder 202. In one embodiment, video encoder 202 may be an encoder-decoder type of neural network architecture. In other embodiments, video encoder 202 may embody various types of neural networks, such as transformers or convolutional neural network (CNN) architectures. Functions of the neural network embodied in video encoder 202 may be implemented using at least one processor of a computer or computing device or multiple computers or computing devices. The goal for the trained neural network is to be able to perform action segmentation of a subject video into a sequence of actions with labels and durations.

For example, given a subject video x^{t}₁=(x₁, . . . , xₜ) with t frames and a single human subject, the goal for the trained neural network is to segment a subject video into a sequence of n actions aⁿ₁=(a₁, . . . , aₙ) and their duration Iⁿ₁=(I₁, . . . , Iₙ). In the present embodiments, which are a weakly-supervised training setting, frame-level action labels are not provided and a sequence of action labels (transcripts) [symbol] ⁿ₁=( [symbol] ₁, . . . , [symbol] ₙ) are assumed to occur throughout the video.

As shown in FIG. 2, precomputed RGB features 204 and human pose features 208, which may be extracted by any frozen off-the-shelf estimator, such as a pre-trained pose extractor 206, are input into training process 200. These RGB features 204 and pose features 208 inputs are processed by individual shallow encoders, including video encoder 202 for RGB features 204 and a pose encoder 210 for pose features 208. The encoders may be implemented in hardware, software, or a combination of hardware and software. In some embodiments, functions of the encoders, including video encoder 202 and pose encoder 210 may be performed by at least one processor executing instructions to implement the functions. In some cases, the processor may be associated with one or more computers or computing devices. Each of RGB features 204 and pose features 208 embeddings are then mapped into a shared representation space 212 (e.g., a joint RGB-pose space) with consistent feature dimensions (e.g., using a common coordinate system).

Subsequently, a contrastive learning loss 214 (L_{con}) is applied to the RGB feature embeddings (e.g., output from video encoder 202) and pose feature embeddings (e.g., output from pose encoder 210) in shared representation space 212, enabling video encoder 202 to learn semantically rich visual representations enriched by data from pose features 208 during a training-only pose learning phase 201. Once video encoder 202 has been trained using contrastive learning loss 214 during pose learning phase 201, the RGB feature embeddings from the trained video encoder 202 are then input into an action segmentation model 216 to perform action segmentation of the test video into a sequence of actions with labels and durations (e.g., prediction 218).

During training, in order to integrate contrastive learning 214 with the original segmentation task, a multi-task setting is used. Here, training process 200 minimizes a joint optimization objective, allowing video encoder 202 to incorporate the data from pose features 208 and steer a segmentation loss 222 to identify correction segments across the test video. That is, segmentation loss 222 (L_{segment}) is applied to prediction 218 of a sequence of actions with labels and durations from the test video using a ground truth transcript 220. In this embodiment, ground truth transcript 220 includes a predetermined sequence of actions with labels and durations that prediction 218 is compared against as part of segmentation loss 222.

With this arrangement, the resulting overall training loss is: L_{Final}=L_{con}+L_{segment}. Where L_{con} is contrastive loss 214 from pose learning phase 201 and L_{segment} is segmentation loss 222 adopted from any weakly-supervised segmentation baseline (e.g., ground truth transcript 220). During subsequent inference phases, only video encoder 202 utilizing the trained neural network is employed to analyze subject videos for action segmentation, omitting pose phase 201 entirely to allow the techniques to be generalizable to various baselines without impacting runtime performance.

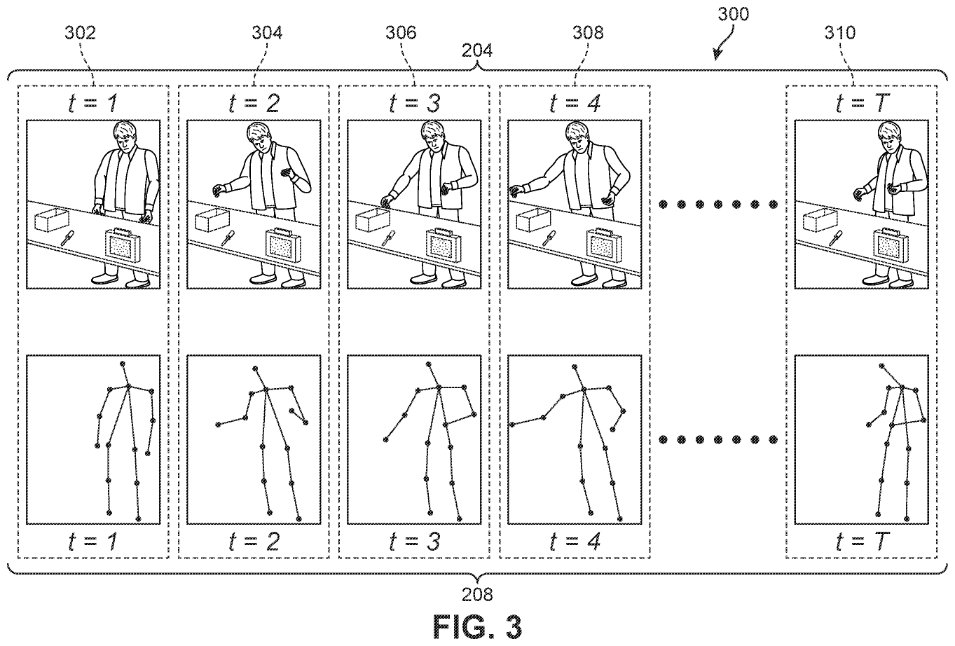

Referring now to FIG. 3, a representative view of an example embodiment of mapping pose features in frames of a test video in a shared representation space is shown. In this embodiment, a representation of pose encoding 300 is shown using RGB features 204 and pose features 208 which are mapped to a shared representation space (e.g., joint RGB-pose space). In an example embodiment, pose encoding 300 may be part of operation 114 of method 100, described above.

As shown in FIG. 3, RGB features 204 and pose features 208 are associated with the same individual frames of a video. For example, in this embodiment, RGB features 204 and pose features 208 at each of a first frame 302, a second frame 304, a third frame 306, a fourth frame 308, and continuing until a T^{th} frame 310 are associated with each other and mapped to a shared representation space.

Given a frame of video at time t, raw pose ρₜ∈Z^{K×2} is a collection of (x, y) coordinates for K human keypoints. Here, K represents the number of 2D keypoints extracted by an external pre-trained pose extractor (e.g., pre-trained pose extractor 206 shown in FIG. 2) and Z is the set of integers. As described above, keypoints of a human subject are reference points associated with the face, hands, and/or body of the subject. Before inputting these raw keypoints to pose encoder 210, a normalization step is performed to ensure they are unaffected by changes in perspective, rotation, and positional offset in the frame. Specifically, each keypoint is centered and scaled with respect to the “center of mass” of the human subject, which is determined by averaging the coordinates of all joints. Subsequently, an angle required to rotate each adjusted keypoint is determined the so that the head and “center of mass” of the human subject align vertically, in order to share the same x coordinates. These normalized 2D keypoints, ρₜ, are then fed into pose encoder 210.

As shown in the following Equations 1-3, pose encoder 210 uses a multi-layer neural network in the form of a light-weight two-layer Multilayer Perceptron (MLP) network to learn rich representations from the pose keypoints and map them to the shared representation space (e.g., joint RGB-pose space). Each encoder layer is structured with sequential steps of layer normalization, ReLU activation, and dropout, with a residual link between layers complemented by max-pooling and a linear projection function ┌ to refine the dimensionality of the resultant pose embedding Pₜ.

$$z 1 = dropout ( ReLU ( LayerNorm ( W 1 {p}_{t} + b 1 ) ) ) , \qquad [ Equation 1 ]$$

$$z 1 = dropout ( ReLU ( LayerNorm ( W 1 {p}_{t} + b 1 ) ) ) , \qquad [ Equation 2 ]$$

$$Pt = Γ ( max pool ( z 2 + z 1 ) ) \qquad [ Equation 3 ]$$

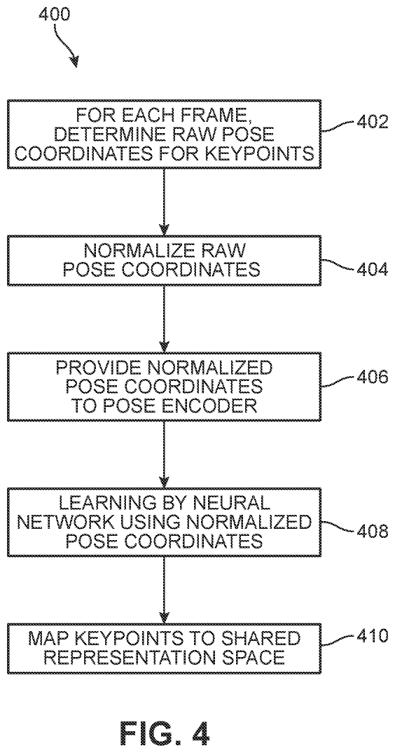

FIG. 4 is a flowchart of an exemplary process 400 of pose encoding (e.g., pose encoding 300 shown in FIG. 3) for training a neural network for pose detection. In an example embodiment, process 400 of pose encoding may be part of operation 114 of method 100, described above. In one embodiment, process 400 may begin with a step 402. At step 402, for each frame of a test video, raw pose coordinates for human subject keypoints are determined. For example, as described above, step 402 may include determining the coordinates of reference points associated with the face, hands, and/or body of the human subject (e.g., keypoints) in the test video. In different embodiments, the keypoints used may vary. For example, in some cases, the keypoints may be between 17 to 133 in number. In other cases, keypoints may be associated with particular body parts, such as the arms and hands of a human subject, or may be associated with additional parts of a human subject, such as a head, torso, legs, and/or feet. In some embodiments, the keypoints used may depend on the type of video being segmented and the performance of the actions depicted therein.

Next, process 400 may include a step 404. At step 404, the raw pose coordinates determined at step 402 are normalized. For example, as described above, the raw pose coordinates for each keypoint are centered and scaled with respect to the “center of mass” of the human subject and an angle required to rotate each adjusted keypoint is determined the so that the head and “center of mass” of the human subject align vertically. Process 400 may then move to a step 406 where the normalized pose coordinates from step 404 are provided to the pose encoder (e.g., pose encoder 210). At a step 408, pose encoder 210 learns rich representations from the normalized pose keypoints utilizing a multi-layer neural network and, at a step 410, maps them to the shared representation space (e.g., joint RGB-pose space).

In an example embodiment, one or more contrastive learning processes are used to determine a contrastive loss that is utilized to create a common space for embedding both RGB feature and pose feature data (e.g., RGB features 204 and pose features 208). This contrastive loss guides video encoder 202 to learn and infuse pose information into its output embeddings from processing RGB frames of the video alone (i.e., without requiring pose extraction).

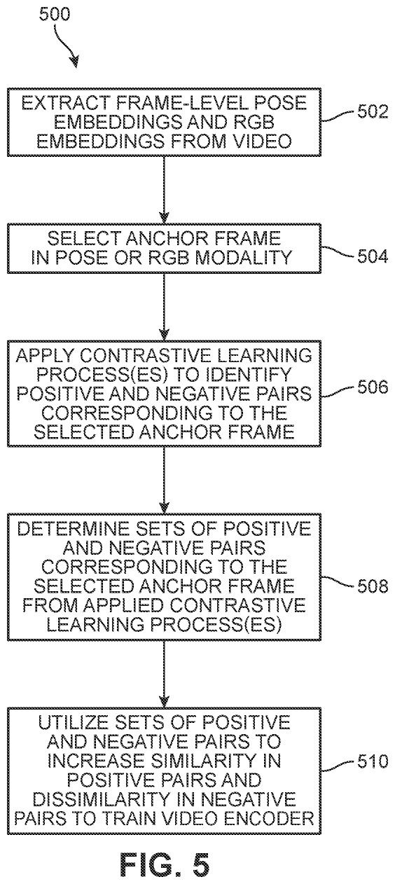

Referring now to FIG. 5, a flowchart of an exemplary process 500 of contrastive learning for training a neural network for pose detection is shown. In this embodiment, contrastive learning process 500 includes a step 502 where frame-level pose embeddings and RGB embeddings are extracted from a video. For example, at step 502, given a video V^{T}₁=(v₁, . . . , v_{T}) with T frames, frame-level pose embeddings P^{T}₁=(P₁, . . . , P_{T}) are extracted and RGB embeddings I^{T}₁=(I₁, . . . , I_{T}) are also extracted, where Iₜ is the output of video encoder 202 at frame t. In different embodiments, various types of neural networks, such as transformers or convolutional neural network (CNN) architectures, may be utilized to implement video encoder 202.

Next, contrastive learning process 500 includes a step 504 where an anchor frame is selected in one of the RGB or pose modality and at a step 506 contrastive learning process(es) are applied to identify positive and negative pairs corresponding to the selected anchor frame from step 504. That is, at step 506, a series of several neighboring frames (e.g., a number of frames before and/or after) the anchor frame is compared for similarity with the anchor frame to determine the positive and negative pairs.

Contrastive learning process 500 also includes a step 508 where sets of the positive and negative pairs corresponding to the selected anchor frame are determined based on the applied contrastive learning process(es) from step 506. For example, at step 508, for each frame t, serving as the anchor frame in one modality (RGB or pose), A(t) represents the set of positive frames (i.e., matching) and Ā(t) represents the set of negative frames (i.e., non-matching), from the other modality within the same video. These sets, A(t) and Ā(t), identify positive and negative instances from the alternate modality that form corresponding pairs with the anchor frame at frame t. At a step 510, the sets of positive and negative pairs for the anchor frame t are utilized by applying the overall contrastive loss (L_{con}) to increase similarity in positive pairs and dissimilarity in negative pairs to train video encoder 202.

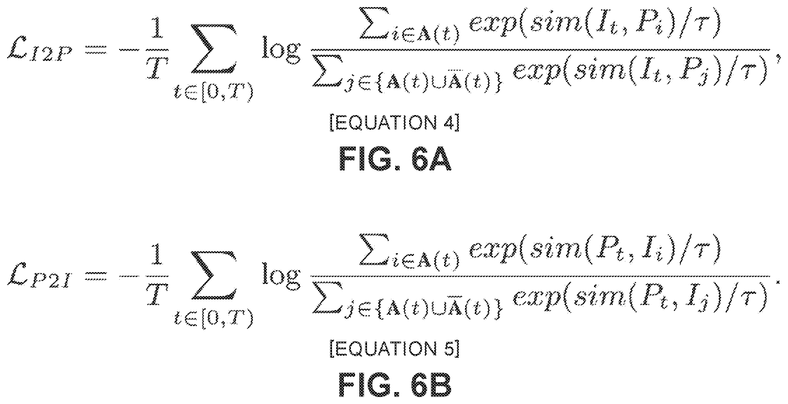

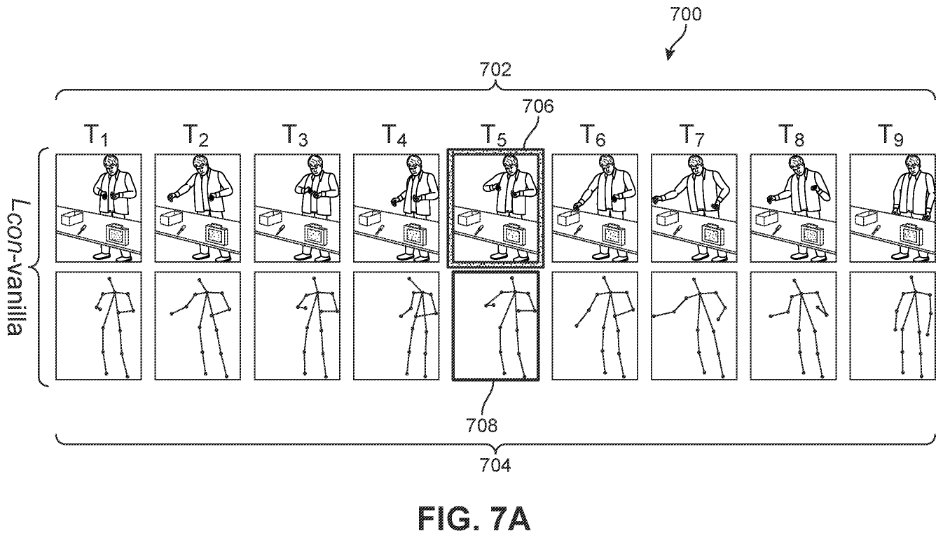

At step 510, contrastive loss (L_{con}) is determined using the equations shown in FIGS. 6A and 6B, with RGB to pose contrastive loss (L_{I2P}) determined using Equation 4 (FIG. 6A) and pose to RGB contrastive loss (L_{P21}) determined using Equation 5 (FIG. 6B), with T being the temperature parameter and where sim denotes the similarity function. With the overall contrastive loss being the sum of both Equation 4 and Equation 5 (L_{con}=L_{I2P}+L_{P2I}).

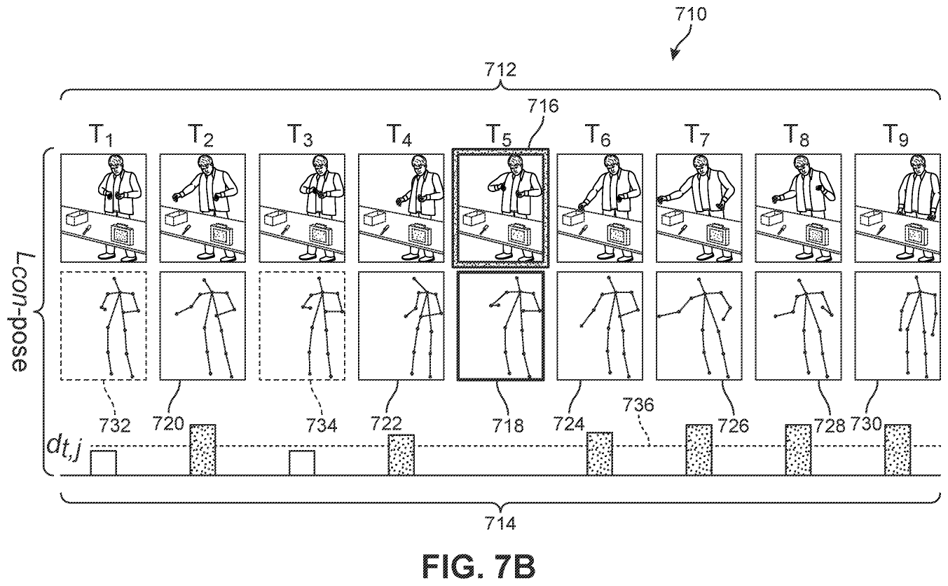

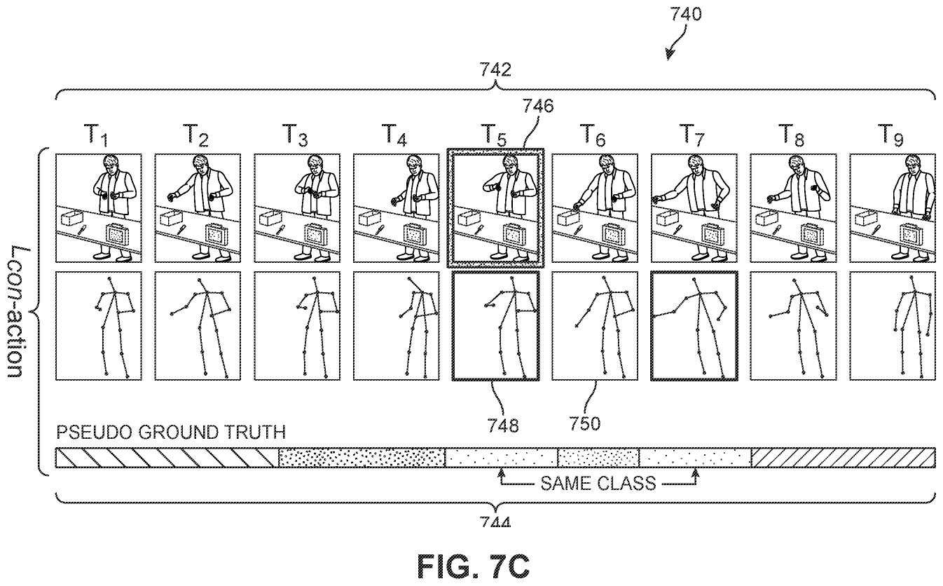

In some embodiments, different contrastive learning process(es) may be used to identify the positive and negative pairs (A(t) and Ā(t)) for determining the contrastive loss. FIGS. 7A-7C represent three different contrastive learning process that may be used to determine the positive and negative pairs (A(t) and Ā(t)) for determining the contrastive loss.

FIG. 7A is a representative view of an example embodiment of a first type of contrastive learning 700. In this embodiment, first type of contrastive learning 700 may be used to determine the contrastive loss, as described above. As shown in FIG. 7A, first type of contrastive learning 700 is a vanilla contrastive learning process (L_{con-vanilla}). In this embodiment, vanilla contrastive learning process 700 is implemented by matching across different modalities (e.g., RGB features 702 and pose features 704) to create a positive pair, and any other frame is considered a negative pair. Formally, for frame anchor t, positive pairs A(t)={t} and negative pairs Ā(t)={j|j∈[0, T) Λj≠t}. For example, as shown in FIG. 7A, for anchor frame 706 at frame T₅ the corresponding pose frame 708 at frame T₅ represents a positive pair (A(t)) and all other frames of pose features 704 (e.g., frames T₁, T₂, T₃, T₄, T₆, T₇, T₈, and T₉) represent negative pairs (Ā(t)).

FIG. 7B is a representative view of an example embodiment of a second type of contrastive learning 710. In this embodiment, second type of contrastive learning 710 may be used to determine the contrastive loss, as described above. As shown in FIG. 7B, second type of contrastive learning 710 is a pose-supervised contrastive learning process (L_{con-pose}). With pose-supervised contrastive learning process 710, the infused pose knowledge does not depend on the action labels, especially in the absence of ground-truth. Since pose configurations are building blocks of actions and may reoccur across different actions, pose knowledge is transferred into video encoder 202 without linking it to specific action categories. In this embodiment, pose-supervised contrastive learning process 710 is implemented by matching across different modalities (e.g., RGB features 712 and pose features 714) to create a positive pair, and any other frame is considered a negative pair. However, with pose-supervised contrastive learning process 710 any negative pairs that feature poses similar to the pose in anchor frame 716 are filtered out, regardless of their occurrence time.

To achieve this filtering, we introduce d_{t,j}=|ρₜ−ρⱼ| as the distance between the normalized key points of frames t and j. Accordingly, we redefine the set of negative frames (Ā(t)) as Ā(t)={j|j∈[0, T)∧d_{t,j}≥δ}, where δ is a predefined threshold. Positive pairs remain the same as with vanilla contrastive learning process 700, e.g., A(t)={t}.

For example, as shown in FIG. 7B, for anchor frame 716 at frame T₅ the corresponding pose frame 718 at frame T₅ represents a positive pair (A(t)) and frames of pose features 714 at frame 620 (T₂), frame 722 (T₄), frame 724 (T₆), frame 726 (T₇), frame 728 (T₈), and frame 730 (T₉) represent negative pairs (Ā(t)). In this embodiment, two negative pair frames, frame 732 (T₁) and frame 734 (T₃) are filtered out from negative pairs (Ā(t)). This filtering is accomplished by comparison of the pose in the frames to anchor frame 716 such that d_{t,j} is not greater than a threshold value 736 (e.g., δ). As shown in FIG. 7B, d_{t,j} for frame 732 (T₁) and frame 734 (T₃) fail to exceed threshold value 736 (δ) and are therefore filtered out of the set of negative pairs (Ā(t)).

FIG. 7C is a representative view of an example embodiment of a third type of contrastive learning 740. In this embodiment, third type of contrastive learning 740 may be used to determine the contrastive loss, as described above. As shown in FIG. 7C, third type of contrastive learning 740 is an action-supervised contrastive learning process (L_{con-action}). In contrast with pose-supervised contrastive learning 710, action-supervised contrastive learning process 740 operates on the premise that pose representations are consistent for action with the same labels. Essentially, action-supervised learning 740 reduces the occurrence of false negatives by treating instances belonging to the same class as positive for each anchor frame and others as negative.

Concretely, if Y(t) is the action label for anchor frame t, then positive pose actions (i.e., poses with action labels within the same class as the anchor frame) are represented by A={j|j∈[0, T)∧Y(j)=Y(t)} and negative pose actions (i.e., poses with action labels that are not within the same class as the anchor frame) are represented by Ā={j|j∈[0, T)∧Y(j)≠Y(t)}.

For example, as shown in FIG. 7C, action-supervised contrastive learning process 740 is applied to frames of RGB features 742 and frames of pose features 744. In this embodiment, for anchor frame 746 at frame T₅ the corresponding pose frame 748 at frame T₅ is within the same class as anchor frame 746. Similarly, pose frame 750 at frame T₇ is also within the same class as anchor frame 746. Thus, in this example, pose frame 748 and pose frame 750 represent positive matches (A) with the same action label class as anchor frame 746 and all other frames of pose features 744 (e.g., frames T₁, T₂, T₃, T₄, T₆, T₈, and T₉) are not within the same action label class as anchor frame 746 and represent negative matches (Ā).

One challenge that arises with weakly labeled videos is that they do not provide frame-level ground-truth for determining matching action label classes. To address this issue, a pseudo-ground-truth generated by the segmentation model (e.g., action segmentation model 216 shown in FIG. 2) is used in each iteration to guide action-supervised contrastive learning process 740.

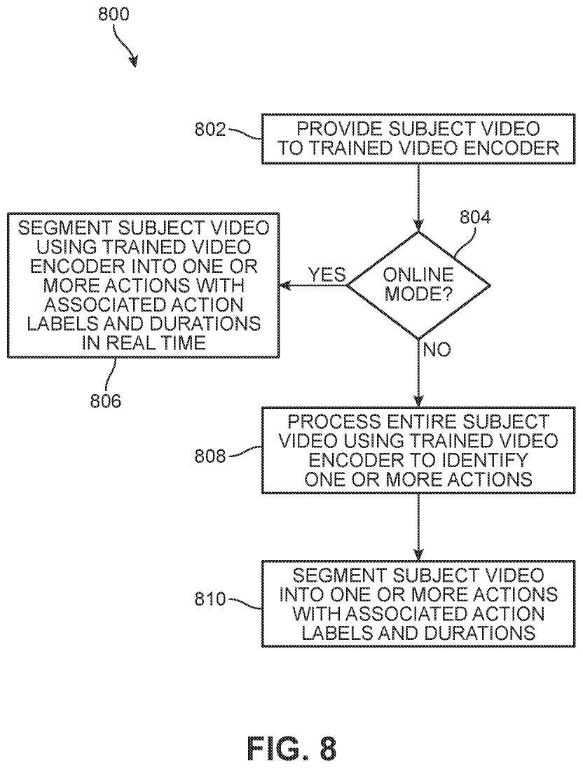

Referring now to FIG. 8, a flowchart of an exemplary method 800 of using a trained neural network to identify action segmentation in instructional videos is shown. In this embodiment, method 800 for action segmentation may be implemented using a trained neural network (e.g., embodied in video encoder 202) that has learned pose knowledge from the training process as detailed above. In this embodiment, method 800 may begin at an operation 802 where a subject video (e.g., a video having one or more actions performed by a human subject) is provided to the trained video encoder (e.g., trained video encoder 202).

Next, method 800 may proceed to an operation 804. At operation 804, whether the video encoder is operating in an online mode is determined. For example, depending on whether the video encoder is performing action segmentation of the subject video in an online mode or an offline mode, a different sequence of operations may follow operation 804. As described above, “online” refers to causal inference in streaming videos for interactive applications, whereas “offline” refers to post-analysis of pre-recorded videos. At operation 804, when the result is YES (i.e., action segmentation is operating in online mode), then method 800 proceeds to an operation 806. At operation 806, the trained video encoder (e.g., video encoder 202) segments the subject video into one or more actions with associated action labels and durations in real time. That is, at operation 806, the subject video is segmented into individual actions in a piecemeal fashion when operating in the online mode. With this arrangement, performing piecemeal segmentation in the online mode reduces the computational load required when segmenting streaming videos.

At operation 804, when the result is NO (i.e., action segmentation is not operating in online mode), then method 800 proceeds to an operation 808. At operation 808, the entire subject video is processed by the trained video encoder (e.g., video encoder 202) to identify one or more actions in the subject video. Method 800 then proceeds to an operation 810 where the subject video is segmented into one or more actions with associated action labels and durations. That is, at operations 808 and 810, the subject video is first processed in its entirety and then is segmented into individual actions in when operating in the offline mode. With this arrangement, the entire subject video may be segmented in whole from a pre-recorded video in the offline mode.

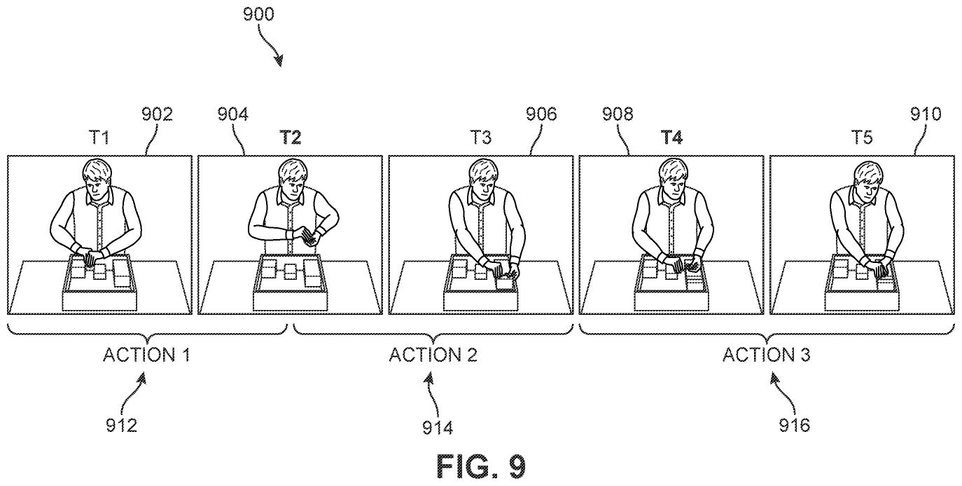

Referring now to FIG. 9, a representative view of an example embodiment of using a trained neural network to identify action segmentation in an instructional video 900 is shown. In this embodiment, a trained neural network embodied in video encoder 202 is used to perform action segmentation of instructional video 900. As shown in FIG. 9, five representative frames of video 900 are shown, including a first frame 902 at T₁, a second frame 904 at T₂, a third frame 906 at T₃, a fourth frame 908 at T₄, and a fifth frame 910 at T₅.

In this embodiment, the trained neural network (e.g., video encoder 202) segments video 900 into one or more actions with durations, including a first action 912 associated with first frame 902 at T₁ into second frame 904 at T₂, a second action 914 associated with second frame 904 at T₂ (starting after first action 912) through third frame 906 at T₃, and a third action 916 from fourth frame 908 at T₄ through fifth frame 910 at T₅. With this arrangement, the techniques of the present embodiments may be used to perform action segmentation on videos, such as video 900 shown in FIG. 9. It should be understood that video 900 may include a number of additional frames depicting additional actions than those shown for purposes of example in FIG. 9. In addition, while generic labels (i.e., first action 912, second action 914, and third action 916) are used in this example, in other embodiments, specific action labels may be provided, such as by providing a transcript or other data that provides labels for the identified actions.

### Experiments

In this section, experiments are described, followed by ablation studies and results of the techniques according to the present embodiments are compared to various baselines on multiple datasets. In the end, qualitative evidence of how pose knowledge contributes to more accurate temporal boundary detection is provided.

Experiments are conducted on three publicly available instructional video datasets: the ATA dataset, the Desktop Assembly dataset, and the IKEA dataset. The ATA dataset contains 1152 toy assembly videos, captured from four different viewpoints, with each video averaging 1.3 minutes long and 12.9 segments. It features 32 participants assembling three different toys with 15 action classes and 96 unique transcripts. Standard subject-based splitting of this dataset is adhered to for test and validation. The Desktop Assembly dataset contains 76 desktop assembly videos, amounting a total of 2 hours, an-notated with 23 action classes and 6 similar transcripts. It is split into 59 training and 17 testing videos. Lastly, the IKEA dataset contains 1113 furniture assembly videos, recorded from three perspectives, with an average duration of 1.9 minutes. The IKEA dataset is categorized into 33 action classes and offers 5 different training/testing splits.

Four metrics are used to evaluate the action segmentation performance according to the techniques of the present embodiments: 1) acc represents the average frame-level accuracy, 2) IoU determines intersection-over-union ratio for each predicted segment, excluding the background frames, 3) Edit employs edit distance to assess the similarity between predicted and ground-truth transcripts, and 4) F1@0.5 assesses the per-class F1 score for predicted segments with an loU threshold of 0.5.

I3D features were extracted from ATA and IKEA datasets, and for Desktop Assembly, ResNet features were used. In experiments with DP as the baseline, the video encoder (e.g., video encoder 202) was implemented with a Transformers model. For MuCon and TASL segmentation baselines, existing temporal convolution and GRU network outputs were used for RGB embedding, respectively. For computational efficiency, pose keypoints were extracted every five frames by RTMPose Body2D. The effect of δ is discussed below. All other parameters, such as the number of training iterations, are set as per baseline settings.

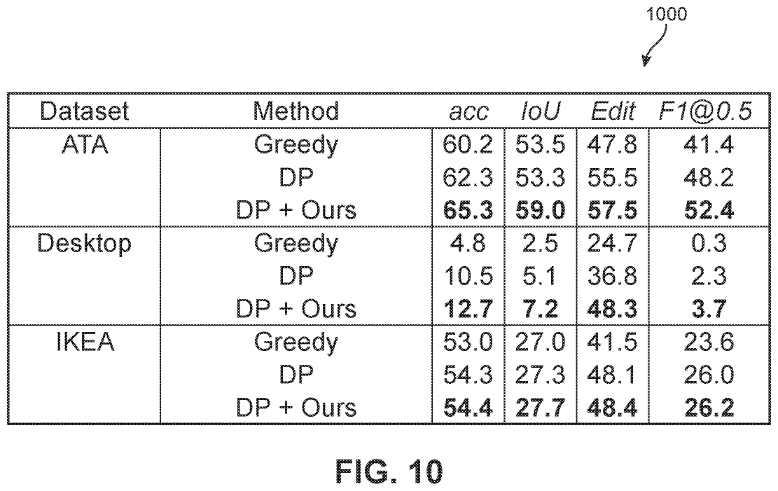

The experimental results show that the techniques of the present embodiments improves both online and offline segmentation results on multiple datasets and baselines. Referring now to FIG. 10, a table 1000 (Table 1) showing results of online segmentation is shown. As shown in Table 1 of FIG. 10, the impact of vanilla contrastive loss (i.e., L_{con-vanilla}) in comparison with previous weakly-supervised online segmentation methods is shown. During training, both Greedy and DP share the same network structure. However, at inference time, Greedy adopts a sliding window approach to predict per-frame actions while DP uses an unconstrained dynamic programming approach based on the available transcripts. As shown in Table 1, infusing pose information into the video encoder of DP elevates its performance across all four metrics and three datasets. Specifically, on ATA and Desktop Assembly Dataset, the loU performance gain is about 5.7% and 2.1%, respectively. The smaller improvements on the IKEA dataset is associated mostly to its 5th split. In many videos of this split, the single person assumption is violated by background people, which negatively impacts the pose encoding accuracy.

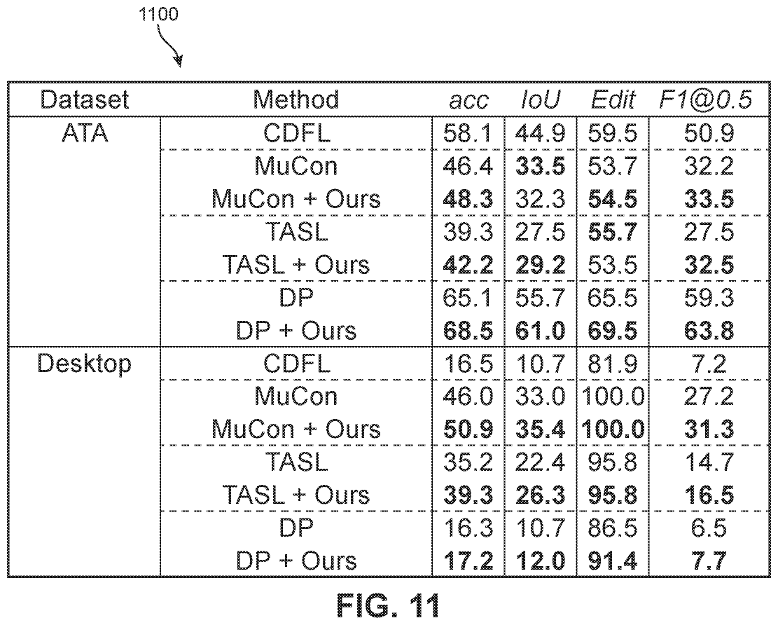

Referring now to FIG. 11, a table 1100 (Table 2) showing results of offline segmentation is shown. As shown in Table 2 of FIG. 11, the vanilla contrastive loss process (i.e., L_{con-vanilla}) is integrated into three state-of-the-art offline segmentation methods, i.e., DP, TASL, and MuCon. As shown in Table 2, infusing pose knowledge into the video encoder consistently improves weakly-supervised performance on the ATA and Desktop Assembly datasets. Despite the differences in network architecture and segmentation technique among various methods, the techniques of the present embodiments may be adapted to all baselines without changing their original architecture. In particular, on Desktop Assembly videos, instilling pose knowledge into the MuCon encoder achieves new SOTA and improves acc and F1 by up to approximately 5%. Also, the high Edit score on Desktop Assembly videos is due to the very similar 6 transcripts of this dataset. Conversely, DP stands out as the best baseline for ATA videos, owing to its design for segmenting unseen sequences in the ATA test set.

### Analysis and Ablation Studies

Performance of the three proposed contrastive learning processes for determining contrastive loss, which are described above with reference to FIGS. 7A-7C are compared, then the present embodiments robustness across various pose extractors are tested, and finally the pose knowledge learned by the trained video encoder (e.g., video encoder 202) is examined. DP and TASL are used as baselines for the ablation study in online and offline segmentation tasks, respectively.

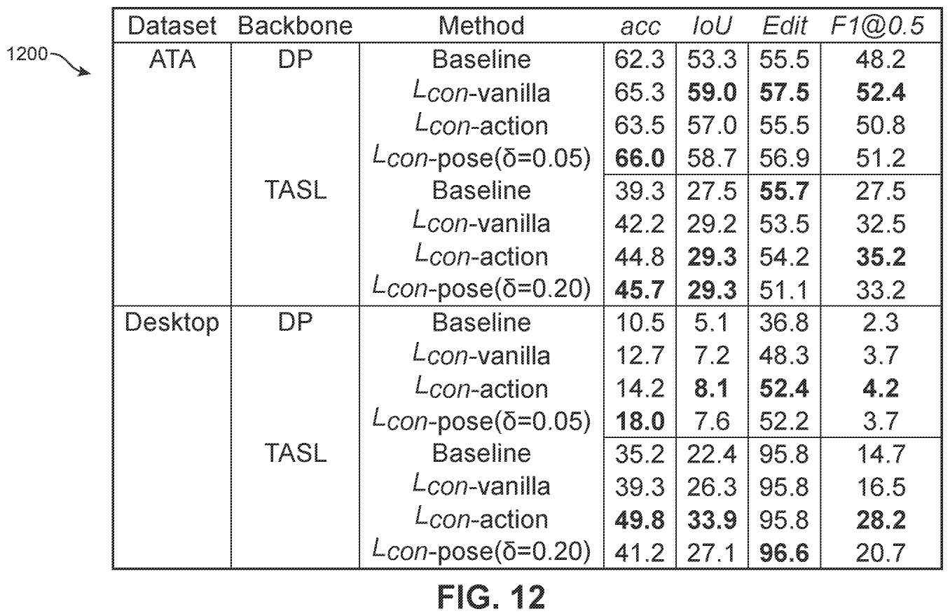

Referring now to FIG. 12, a table 1200 (Table 3) showing a comparison of the different contrastive learning processes in accordance with aspects of the present disclosure is shown across four different experimental settings, where each setting is a combination of a backbone and dataset. Additionally, DP was utilized for online segmentation and TASL was utilized for offline segmentation tasks. All three contrastive learning processes outperform the baseline in all weakly-supervised segmentation experiments, demonstrating how the trained video encoder according to the present disclosure significantly benefits from the pose knowledge infusion.

In 3 out of 4 settings, vanilla contrastive learning (i.e., L_{con-vanilla}) is found to be inferior to the other contrastive learning processes, as it introduces a higher number of false negative samples that confuse the video encoder. On the other hand, neither the pose-supervised contrastive learning process (L_{con-pose}) nor the action-supervised contrastive learning process (L_{con-action}) show a consistent advantage over the other. Specifically, the action-supervised contrastive learning process (L_{con-action}) is limited by the accuracy of the pseudo-ground-truth and fails to account for pose variations within the same segment. However, it does not rely on hyperparameters for mining negative and positive instances.

The sensitivity of the threshold δ (e.g., threshold 736 shown in FIG. 7B) in the pose-supervised contrastive learning process (L_{con-pose}) may vary. Notably, incorporating the pose-supervised contrastive learning process (L_{con-pose}) enhances performance over the baseline across all threshold values. δ varies from 0, where no negative frames are removed, to a sufficiently high value that leads to the removal of all negative samples for contrastive learning. The results converge to the baseline as all negative samples are removed. Also, note that vanilla contrastive learning (i.e., L_{con-vanilla}) may be considered a special case of the pose-supervised contrastive learning process (L_{con-pose}) when δ=0.

The statistics of the pose distance d_{t,j} between any two frames t and j of a video is sensitive to the viewpoint. Hence, in a dataset like ATA, which features multiple viewpoints, finding a fixed effective threshold across all views is challenging. This is because a threshold value that is low for one viewpoint may be too high for another, leading to the removal of true negative frames. Consequently, this partially explains why the pose-supervised contrastive learning process (L_{con-pose}) is outperformed by vanilla contrastive learning (i.e., L_{con-vanilla}) on the ATA dataset when using DP as the baseline.

The robustness of the techniques of the present embodiments may be assessed by examining its performance with two different pose extractors. For example, RTMPose Body2D and RTMPose WholeBody2D extractors are utilized to integrate pose into vanilla contrastive learning (i.e., L_{con-vanilla}). The main difference between these pose extractors is the level of keypoint detail. The RTMPose WholeBody2D extractor identifies 133 fine-grained keypoints across the face, hands, and body, whereas RTMPose Body2D identifies 17 more sparse sets of keypoints.

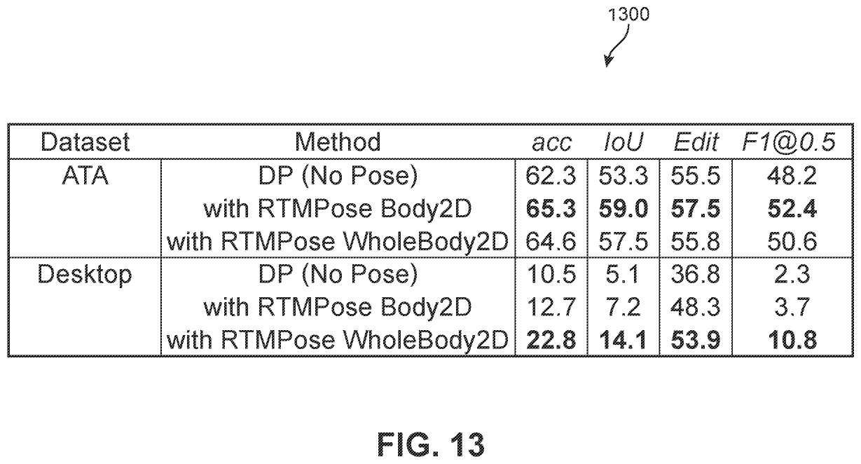

Referring now to FIG. 13, a table 1300 (Table 4) showing results of a trained neural network according to the present embodiments for pose detection is shown. As shown in Table 4, the trained video encoder according to the present embodiments outperforms the DP baseline on both the ATA and Desktop Assembly datasets, regardless of the extractor used, indicating its adaptability to different levels of pose detail. Table 4 further suggests that a higher number of keypoints results in competitive or larger improvements, due to the more detailed pose representations. This improvement is shown to be more substantial in the Desktop Assembly dataset, which is smaller in size compared to the ATA dataset.

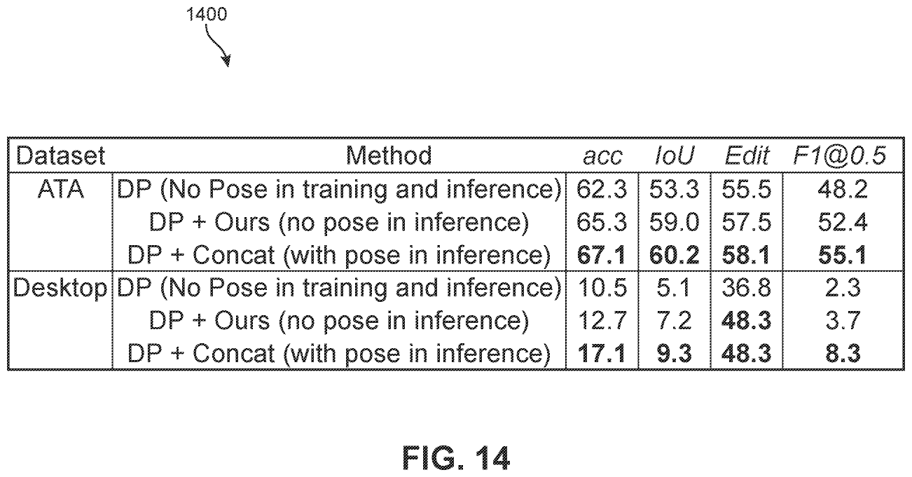

Referring now to FIG. 14, a table 1400 (Table 5) showing a comparison of methods of online segmentation in accordance with aspects of the present disclosure is shown. The extent to which pose knowledge, acquired during training, is applied during inference in the absence of an explicit pose modality is demonstrated. To investigate this, an experiment is conducted where, rather than infusing pose knowledge, pose keypoints are extracted during both training and inference phases. In this setup, pose and RGB embeddings are merged prior to input into the segmentation model, and trained with the same loss as the techniques of the present embodiments to allow for a direct comparison. The concatenation baseline serves as the upper bound of the proposed method. As shown in FIG. 14, Table 5 shows the video encoder according to the techniques of the present embodiments effectively assimilates pose knowledge through contrastive learning, often yielding performance comparable to its upper bound, even without direct use of pose information during inference.

The techniques described herein provide a method of training a neural network that leverages human pose knowledge for human action segmentation in long instructional videos with limited supervision. The exemplary embodiments describe interactions between video sequences and human pose sequences during training and avoid using pose features at inference. Extensive experiments on representative datasets demonstrate the efficacy of the present method as it outperforms the previous state-of-the-art methods in segmenting long instructional videos under both online and offline settings. Furthermore, techniques described herein may be extended to various segmentation backbones, pose extractors, and contrastive learning methods for several representative datasets.

The trained neural network of the present embodiments may be used for action segmentation of videos in various settings, including, but not limited to automatically detecting assembly worker actions in an assembly or manufacturing facility, providing statistics and time data required for various action processes, error analysis for determining corrective actions, understanding of human actions for use in various human-machine or human-robot interactions, and for other types of instructional and/or coaching settings, where detailed identification and segmentation of individual actions may be useful.

While various embodiments of the disclosure have been described, the description is intended to be exemplary, rather than limiting and it will be apparent to those of ordinary skill in the art that many more embodiments and implementations are possible that are within the scope of the disclosure. Accordingly, the disclosure is not to be restricted except in light of the attached claims and their equivalents. Also, various modifications and changes may be made within the scope of the attached claims.

1. A computer-implemented method of training a neural network for pose detection comprising:
obtaining a test video with a plurality of actions;
inputting RGB features from the test video to a video encoder;
applying the video encoder to the RGB features from the test video to output RGB feature embeddings;
inputting pose features from the test video to a pose encoder;
applying the pose encoder to the pose features from the test video to output pose feature embeddings;
mapping the RGB feature embeddings and the pose feature embeddings to a shared representation space;
utilizing a contrastive loss to train the video encoder; and
identifying one or more action segments in the test video using the trained video encoder.

2. The method according to claim 1, wherein the contrastive loss is determined using at least one contrastive learning process.

3. The method according to claim 2, wherein the at least one contrastive learning process includes a vanilla contrastive learning process.

4. The method according to claim 2, wherein the at least one contrastive learning process includes a pose-supervised contrastive learning process.

5. The method according to claim 4, wherein the pose-supervised contrastive learning process is associated with a predetermined threshold value for determining negative pair sets.

6. The method according to claim 2, wherein the at least one contrastive learning process includes an action-supervised contrastive learning process.

7. The method according to claim 1, wherein the RGB features and the pose features are associated with a plurality of keypoints of a human subject in the test video.

8. The method according to claim 7, wherein the plurality of keypoints includes reference points associated with a face, hands, and/or a body of the human subject in the test video.

9. The method according to claim 8, wherein the plurality of keypoints are normalized prior to the step of mapping the RGB embeddings and the pose embeddings to the shared representation space.

10. The method according to claim 1, further comprising extracting the pose features from the test video using a pre-trained pose extractor.

11. A computer-implemented method of using a trained neural network to perform action segmentation of a subject video comprising:
training a neural network embodied in a video encoder with a test video to infuse pose knowledge into the trained neural network;
providing a subject video to the trained neural network; and
segmenting the subject video into one or more actions with associated labels and durations utilizing the trained neural network.

12. The method according to claim 11, further comprising:
determining whether the neural network is operating in an online mode; and
upon determining that the neural network is operating in the online mode, performing the step of segmenting the subject video in real-time.

13. The method according to claim 11, further comprising:
determining whether the neural network is operating in an online mode; and
upon determining that the neural network is not operating in the online mode, processing an entirety of the subject video to identify the one or more actions prior to performing the step of segmenting the subject video.

14. The method according to claim 11, wherein the step of segmenting the subject video into one or more actions is performed by the video encoder without extracting pose features from the subject video.

15. The method according to claim 11, wherein training the neural network includes utilizing at least one contrastive learning process to train the video encoder.

16. The method according to claim 15, wherein the at least one contrastive learning process includes a vanilla contrastive learning process.

17. The method according to claim 15, wherein the at least one contrastive learning process includes a pose-supervised contrastive learning process.

18. The method according to claim 17, wherein the pose-supervised contrastive learning process is associated with a predetermined threshold value for determining negative pair sets.

19. The method according to claim 15, wherein the at least one contrastive learning process includes an action-supervised contrastive learning process.

20. The method according to claim 11, wherein the labels associated with the one or more actions are provided with a transcript of the subject video.
